(19) United States
(12) Patent Application Publication
(10) Pub. No.: US 2017/0368450 A1
(43) Pub. Date: Dec. 28, 2017

(54) CONTROLLER LANYARD SYSTEM

(71) Applicant: Larry Lamb, New Iberia, LA (US)

(72) Inventor: Larry Lamb, New Iberia, LA (US)

(21) Appl. No.: 15/190,862

(22) Filed: Jun. 23, 2016

(51) Int. Cl. A63F 13/24

(52) U.S. Cl. CPC A63F 13/24

(57) ABSTRACT

Supported two handed controllers usable with video games are disclosed that include a controller body with a back, a front, a lanyard and a joining structure. The joining structures may attach to the controller body at a body joining point near the controller body center of gravity and near a controller symmetry plane such that the controller body is able to freely hang from the lanyard by the joining structure with the controller back above the controller front and with the controller at a distance from the user that is comfortable for both play and short term retention when not actively engaged in play.

Controller lanyard systems described herein may be used in video gaming as an aid to comfort and controller accessibility. Certain controller lanyard systems disclosed herein may provide enhanced controller accessibility and comfort during extended videogame play.

### BRIEF DESCRIPTION OF THE DRAWINGS

FIG. 1 shows a joining structure including a replacement battery door.

FIG. 2 shows a side view of a joining structure including a replacement battery door.

FIG. 3 shows a controller hanging from a lanyard.

### DETAILED DESCRIPTION

### Example 1

A controller such as the Xbox One game controller sold by Microsoft or other game controller, as are typically used to play video games, may have the battery compartment door replaced by a controller support system that may allow the game controller to hang from the neck of a user by a lanyard. The lanyard may have a length that is suitable to allow the user to control the game within a substantial portion of the arm's length reach of the user without pulling the lanyard taught around the neck of the user. When not engaged in active play, the controller support system may position the controller near waist level and oriented such that the user may grasp the controller without the need for rotating the controller in a significant way. Such orientation may be an orientation in which the replacement battery door faces the body of the user and the top face of the controller faces outward. In such an orientation, the controller may rotate about a vertical axis but may have more limited rotation about any horizontal axis.

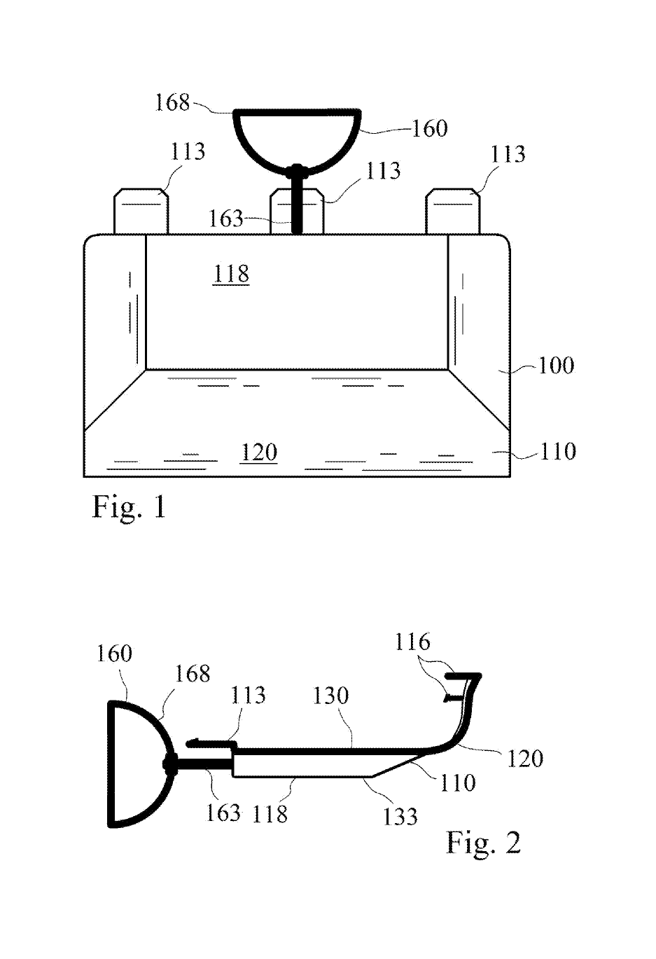

Referring now to FIGS. 1 and 2 of the drawings, Controller support system 100 may comprise a Replacement battery door 110, a D-Ring swivel 160, and a Lanyard 200 (not shown). Replacement battery door 110 may have a First set of battery compartment tabs 113, a Second set of battery compartment tabs 116, a Reinforced section 118, a Bend 120, an Inner surface 130 and an Outer surface 133. D-Ring swivel 160 may have a Support post 163 and a D-Ring 168 for attaching a lanyard.

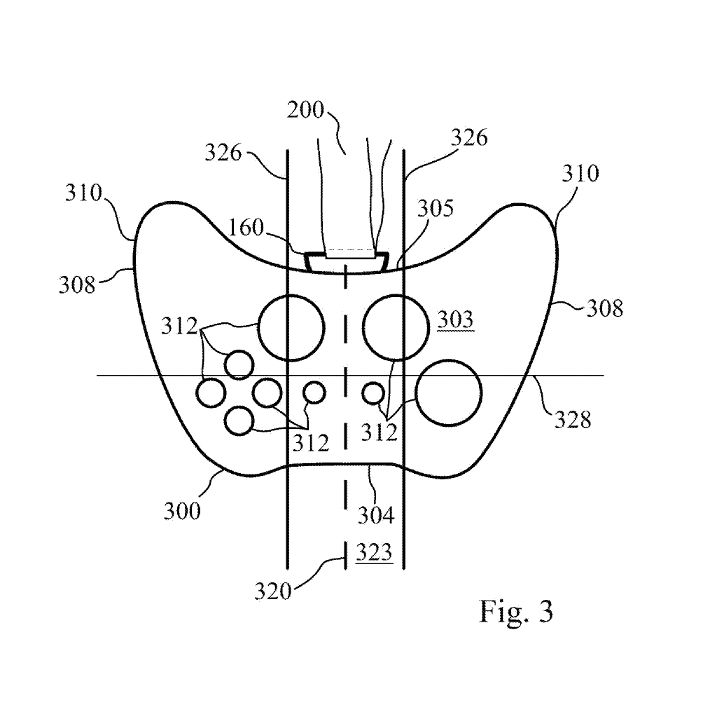

Referring now to FIG. 3 of the drawings, Controller 300 may have a Controller top face 303, a Controller front 304, a Controller back 305, Controller sides 308, Controller grips 310, Controller top face controls 312, a Controller symmetry plane 320, Controller symmetry space 323, Controller symmetry space boundaries 326 and front-back dividing plane 328. D-Ring swivel 160 and Lanyard 200 are also shown. As described herein, the controller back is generally the portion of the controller proximal to the user when the controller is being used and the controller front is the portion of the controller that is distal to the user. As described herein, the controller bottom is generally the region of the controller on which the controller rests when placed on a flat surface in the typical orientation for storing the controller and the region of the controller opposite Controller top face 303. The controller bottom-top dividing plane is the plane that passes through the controller center of gravity that is parallel to the plane on which the controller would typically rest when the controller is resting in the normal resting position on that plane. The controller bottom-top dividing plane is specific to the controller such that Controller top face 303 would be on the top side of the controller bottom-top dividing plane regardless of the orientation of the controller. The space above the controller bottom-top dividing plane that includes the Controller top face 303 may be referred to herein as the “controller top side space” and the space on the opposite side of the controller bottom-top dividing plane may be referred to herein as the “controller bottom side space.” The controller top is generally the region of the controller containing Controller top face 303. As that phrase is used herein, the “controller symmetry plane” is the plane that passes through the controller center of gravity and best divides the controller into two substantially symmetrical portions each of the two substantially symmetrical portions containing a controller grip. Actual or perfect symmetry is not required for the identification of the controller symmetry plane. As used herein, the “front-back dividing plane” is the plane perpendicular to both the controller bottom-top dividing plane and the controller symmetry plane. As used herein, the “controller front side space” is the space on the side of the front-back dividing plane containing Controller front 304 and the “controller back side space” is the space on the side of the front-back dividing plane containing Controller back 305. Replacement battery door 110 may have flush mounting tapered edges that match the contour of Controller back 305 in one or more places where Replacement battery door 110 contacts Controller back 305. As described herein, the controller center of gravity is measured without batteries in cases where the batteries are removable and with batteries when the batteries are not removable.

Lanyard 200 may have a longer than conventional flexible lanyard material length which may, for example, be 54 inches with certain examples falling between 42 and 74 inches and a significant number of those examples falling between 48 and 64 inches. The length of the lanyard together with certain joining components may also be expressed in terms of the maximum distance that the lanyard can extend away from the controller which is referred to herein sometimes as the “maximum lanyard separation distance.” The maximum lanyard separation distance may, for example, be 29 inches with certain examples falling between 23 and 38 inches and a significant number of those examples falling between 26 and 34 inches.

D-Ring 168 may be configured to swivel or rotate around Support post 163. Support post 163 may be securely embedded within Reinforced section 118 such that Support post 163 has neither rotational or translational movement relative to Reinforced section 118. First set of battery compartment tabs 113 and Second set of battery compartment tabs 116 may be configured to securely snap into Controller 300 to seal batteries within the battery compartment of a controller such that Inner surface 130 faces the batteries of the controller and Outer surface 133 faces outward relative to the controller. Reinforced section 118 may be thicker than a conventional controller battery door housing for the purposes of securely holding D-Ring swivel 160 in place. However, other forms of attachment may be used that preserve the orientation of the controller. Bend 120 along with the other body components of Controller support system 100 is configured to generally match the contours of the original equipment manufacturer battery door.

### Example 2

In an alternate embodiment, D-Ring swivel 160 or one of the many other various form suitable for attaching a lanyard may be separated from the controller by a hook and loop fastener, a quick disconnect coupling or some other form of removable attachment. In the case of a hook and loop fastener the pieces or joining elements of the loop fastener may be located approximately in the region of Reinforced section 118 as depicted in FIG. 2. Embodiments containing a quick disconnect and embodiments containing other metal to metal removable fasteners may be located in the region of D-Ring swivel 160 either as a replacement for D-Ring swivel 160 or as a supplement to D-Ring swivel 160.

### Example 3

In an alternate example, the joining structure may be configured to attach to another portion of the exterior shell of the controller body without involving the controller battery door. In such cases, adhesives such as epoxy may be used to provide a resilient connection to the exterior shell of the controller body.

As that term is used herein “two handed controller” indicates controllers configured for two handed holding and operation with separate sets of controls associated with left hand operation and right hand operation. By way of example, an Xbox One controller and the controller depicted in FIG. 3 would both be two handed controllers and a television remote control would not be a two handed controller. As that term is used herein “bending joint” indicates a joint between two or more connected components allowing significant relative movement beyond swiveling such that ball and socket joints, hinge joints, two connected chain links and the connection between D-Ring 168 and Lanyard 200 would each be considered bending joints. Conversely, the swivel joint between Support post 163 and D-Ring 168 would not be considered a bending joint. As that term is used herein, the “first bending joint” indicates the bending joint among any number of bending joints present in either the lanyard or any joining structure that is closest to the controller center of gravity. For example, in a case where the joining structure was a completely rigid body with no joints and a flexible lanyard looped through a hole in the joining structure the point where the lanyard met the joining structure would be the first bending joint. The first bending joint separation distance is the distance between the controller center of gravity and the first bending joint. The first bending joint separation distance may, for example, be 2.3 inches with certain examples falling between 1.0 and 4.5 inches and a significant number of those examples falling between 1.7 and 3.4 inches.

Supported controllers described herein may, for example comprise a controller body having a controller back and a controller front; a lanyard; a joining structure connecting the controller body to the lanyard; and a controller symmetry plane running through the controller body such that the controller body has a controller body center of gravity; the controller body is arranged and configured as a two handed controller; the joining structure attaches to the controller body at a body joining point within 3.0 inches of the controller body center of gravity; the body joining point is within 0.7 inches of the controller symmetry plane; the controller body is configured to freely hang from the lanyard by the joining structure such that the controller back is above the controller front; and the lanyard has a flexible lanyard material length greater than 42 inches. The joining structure may include both Inner surface 130 and D-Ring swivel 160. As depicted in FIG. 1, the body joining point may be the perimeter of Controller support system 100 that contacts the outer shell of the controller body. In a related example, the joining structure may be attached to the lanyard in a controller back side space. In a related example, the joining structure may be configured to have a maximum lanyard separation distance of between 23 and 38 inches. In a related example, the joining structure may avoid altering a normal flat surface resting position of the controller body. In such case a user could lay down the controller with the lanyard in a manner similar to the way that the controller would typically be laid down without interference from the joining structure. In a further related example, the joining structure may attach to the controller body in the controller back side space. In a further related example, a first portion of the joining structure may be an integral component of an outer shell of the controller body. In a further related example, the joining structure may comprise a battery door. In a further related example, the battery door may comprise battery compartment tabs projecting from the battery door toward the controller back. In a further related example, the joining structure comprises a swivel joint. In a still further related example, the controller body may be arranged and configured for removable attachment from the lanyard. In a further related example, the joining structure may comprise a post arranged and configured for rigid attachment to the controller body. In a still further related example, at least one component of the joining structure may be arranged and configured for flush mounting to the controller body. In a still further related example, the joining structure and the lanyard may have a first bending joint separation distance between 1.0 and 4.5 inches. In a still further related example, the joining structure and the lanyard may have a first bending joint separation distance between 1.7 and 3.4 inches.

The above-described embodiments have a number of independently useful individual features that have particular utility when used in combination with one another including combinations of features from embodiments described separately. There are, of course, other alternate embodiments which are obvious from the foregoing descriptions, which are intended to be included within the scope of the present application.

1. A supported controller comprising:
a. a controller body having a controller back and a controller front;
b. a lanyard;
c. a joining structure connecting the controller body to the lanyard; and
d. a controller symmetry plane running through the controller body;
e. wherein the controller body has a controller body center of gravity;
f. wherein the controller body is arranged and configured as a two handed controller;
g. wherein the joining structure attaches to the controller body at a body joining point within 3.0 inches of the controller body center of gravity;
h. wherein the body joining point is within 0.7 inches of the controller symmetry plane;
i. wherein the controller body is configured to freely hang from the lanyard by the joining structure such that the controller back is above the controller front; and
j. wherein the lanyard has a flexible lanyard material length greater than 42 inches.

2. The supported controller of claim 1 wherein the joining structure is attached to the lanyard in a controller back side space.

3. The supported controller of claim 1 wherein the lanyard and the joining structure are configured to have a maximum lanyard separation distance of between 23 and 38 inches.

4. The supported controller of claim 1 wherein the joining structure does not alter a normal flat surface resting position of the controller body.

5. The supported controller of claim 1 wherein:
a. the joining structure is attached to the lanyard in a controller back side space;
b. the lanyard and the joining structure are configured to have a maximum lanyard separation distance of between 23 and 38 inches and
c. the joining structure does not alter a normal flat surface resting position of the controller body.

6. The supported controller of claim 5 wherein the joining structure attaches to the controller body in the controller back side space.

7. The supported controller of claim 5 wherein a first portion of the joining structure is an integral component of an outer shell of the controller body.

8. The supported controller of claim 5 wherein the joining structure comprises a battery door.

9. The supported controller of claim 5 wherein:
a. the joining structure attaches to the controller body in the controller back side space;
b. a first portion of the joining structure is an integral component of an outer shell of the controller body and
c. the joining structure comprises a battery door.

10. The supported controller of claim 9 wherein the battery door comprises battery compartment tabs projecting from the battery door toward the controller back.

11. The supported controller of claim 9 wherein the joining structure comprises a swivel joint.

12. The supported controller of claim 9 wherein the controller body is arranged and configured for removable attachment from the lanyard.

13. The supported controller of claim 9 wherein the joining structure comprises a post arranged and configured for rigid attachment to the controller body.

14. The supported controller of claim 9 wherein at least one component of the joining structure is arranged and configured for flush mounting to the controller body.

15. The supported controller of claim 9 wherein:
a. the joining structure comprises a swivel joint;
b. the controller body is arranged and configured for removable attachment from the lanyard;
c. the joining structure comprises a post arranged and configured for rigid attachment to the controller body and
d. at least one component of the joining structure is arranged and configured for flush mounting to the controller body.

16. The supported controller of claim 1 wherein the joining structure and the lanyard have a first bending joint separation distance between 1.0 and 4.5 inches.

17. The supported controller of claim 5 wherein the joining structure and the lanyard have a first bending joint separation distance between 1.0 and 4.5 inches.

18. The supported controller of claim 15 wherein the joining structure and the lanyard have a first bending joint separation distance between 1.7 and 3.4 inches.
